(19) United States
(12) Patent Application Publication
(10) Pub. No.: US 2004/0080627 A1
(43) Pub. Date: Apr. 29, 2004

(54) Video recording camera system

(76) Inventors: James Clarence Kroll, Nacogdoches, TX (US); Harry Albert Jacobson, Athens, TX (US); Benjamin Henry Koerth, JR., Woden, TX (US)

Correspondence Address: THOMPSON & KNIGHT L.L.P., PATENT PROSECUTION DEPARTMENT, 98 SAN JACINTO BLVD., SUITE 1900, AUSTIN, TX, 78701, US

(21) Appl. No.: 10/618,094

(22) Filed: Jul. 11, 2003

Related U.S. Application Data
(60) Provisional application No. 60/395,600, filed on Jul. 11, 2002.

(51) Int. Cl. H04N 5/228

(52) U.S. Cl. 348/221.1

(57) ABSTRACT

A video recording system for effectively recording video images of unaware subjects under a broad range of lighting conditions automatically in response to detection of motion by such subject using a camera system having controls enabling selective operation of such camera system. The video recording system comprises a motion detector operatively associated with such a camera system in order to selectively produce, in response to detection of motion as by such a subject, an output signal for selectively adjusting such camera's light sensitivity and for selectively causing such camera system to begin recording video images of such subject. The video system also comprises a light sensitivity adjustment system for ensuring that such camera is able to effectively record video images of such subject under such broad range of lighting conditions in response to receipt of the output signal. The light sensitivity adjustment system comprises a photodetection module operatively associated with the camera system, adapted to detect a light level external to such camera system under which light level an unaware subject would be recorded on video images by such a camera system, and including a camera sensitivity control interface to selectively adjust such camera controls governing the light sensitivity of such camera in order to cause such camera system to have a desired light sensitivity to enable effective video recording of such subject.

Furthermore, the video recording system can comprise a filter system in order to control the light level reaching the camera system in order to adjust for a known light sensitivity of the camera system. Alternatively, the video recording system can comprise an infrared lamp system for casting infrared light upon a subject to be recorded by the camera system.

Additionally, a method of video recording comprises detecting motion as by such a subject. Upon detection of motion, an output signal is produced for causing such camera system to begin recording video images of such subject. Upon receipt of the output signal, a light level external to such camera system is detected within which light level an unaware subject is oriented. The capacity of the camera system to record video images of an unaware subject under the environmental lighting conditions under which the unaware subject is susceptible to recordation by the camera system is selectively adapted.

### CROSS REFERENCE TO RELATED APPLICATIONS

This application claims the benefit of the priority date of U.S. Provisional Patent Application No. 60/395,600, filed on Jul. 11, 2002, and entitled, “Infrared-Triggered Camera System” under 35 U.S.C. § 120.

Any references cited hereafter are incorporated by reference to the maximum extent allowable by law. To the extent a reference may not be fully incorporated herein, it is incorporated by reference for background purposes and indicative of the knowledge of one of ordinary skill in the art.

### BACKGROUND OF THE INVENTION

1. Field of the Invention

The present invention relates generally to the field of video monitoring equipment. In particular, the present invention relates to a system for automatic capture of video images.

2. Description of Related Art

The use of video cameras to record information in outdoor settings has been done before. For example, three Trophyview Video Observation Systems, TV-24 B/W, TV-12, and TV-12C, marketed by Wildlife Surveillance Systems Inc. (Trophyview Systems) are video monitoring equipment used to record video information in remote outdoor settings. The Trophyview Systems have been marketed as having some or all of the following features:

include automatic power on and off,

videotape all animals that enter the infrared detection zone,

include a motion sensor that utilizes multilevel signal processing and temperature compensation for detection,

use standard VHS tapes,

overlay a time/date stamp on all recordings,

are contained in a weather-resistant housing,

use two 12-volt DC rechargeable batteries, and

are placed on the ground for recording video.

The TV-24 B/W includes infrared illumination and recording capability to record without color during daylight and nighttime lighting conditions. The TV-24 B/W is supposed to turn itself on automatically and videotape any animal that enters a passive infrared detection zone. It is supposed to continue to videotape as long as the animal remains in the detection zone. Thirty seconds after the last motion is detected the TV-24 B/W is supposed automatically turn itself off.

The TV-12 C system records in color during daylight lighting conditions, and the TV-12 B/W system records without color during daylight lighting conditions.

The current state of video monitoring equipment leaves a significant number of problems, shortcomings, and issues unresolved to monitor remote locations.

In using a video camcorder for surveillance purposes over extended periods of time, it becomes necessary to increase the sensitivity of the camera and to periodically illuminate the area under surveillance with infrared light at night. During daylight hours the camera's sensitivity must be decreased in order to keep from saturating the camera's picture-generating sensor (CCD) and “washing out” the image.

In order to allow infrared photography to be performed at night, some video camcorders (SONY) have a mechanical switching device that allows a filter normally interposed between the lens and the CCD to be removed from the optical path. This allows the maximum sensitivity of the camera to be achieved. SONY calls this setting “NIGHT SHOT” and it must be mechanically engaged and disengaged. If a surveillance system is expected to operate unattended over an extended period of time, then the camera's mechanical NIGHT SHOT switch must normally be actuated by an external mechanical actuator at dawn and at dusk in order to allow the camera to capture images regardless of ambient lighting conditions. Because of the expense of the design and production of the external mechanical actuator and the intricacies involved with its installation and subsequent removals and re-installations as the camera itself is removed and replaced for tape changes, maintenance, etc., the external mechanical actuator has limitations and disadvantages.

The Trophyview Systems are not programmable. Also, the cameras used in the Trophyview Systems and similar systems are built-in cameras that cannot be readily removed and are not readily adaptable to use with a standard camcorder.

Furthermore, remote monitoring systems such as the Trophyview Systems have camera and sensor units that are not readily separable. There are situations in which it is advantageous to detect motion or ambient light separately from the camera location. It is therefore desirable to provide a remote monitoring system capable of sensing motion and recording video separately.

The systems are not configured to be mounted on trees or posts. Furthermore, the Trophyview Systems each weigh around 30 pounds and are 18.8 inches×11.2 inches×12 inches, occupying 1.46 ft³. It is therefore desirable to provide a remote monitoring system that is adapted for use with trees, posts, or the like.

### BRIEF SUMMARY OF THE INVENTION

The present invention is directed to a self-contained, battery operated, programmable video and digital photo recording system with a camcorder and circuitry to facilitate automatic, unattended, around the clock operation. The system is adapted for a 120 Volt AC mains-powered charger, a photovoltaic array, or a 12 Volt external power cable to charge the internal battery. The system is capable of day (high-light) and night (low-light) conditions.

The motion detection system operates to detect an event when an associated motion detector is triggered. Upon detection of an event, the camera system operates to record video information for a period of time. During periods of nighttime lighting levels the infrared lamp system operates in conjunction with the camera system to provide sufficient lighting to allow the camera system to successfully record the video information. The filtering system automatically engages during periods of daylight lighting levels to neutrally filter out light. Sufficient light is thereby filtered out to allow the camera system to operate in a high-photosensitive mode during periods when lighting levels would otherwise be too great to successfully record the video information. During periods of nighttime lighting levels, the filtering system automatically disengages. The computing system coordinates other system components and manages stored video information, for example, by event.

The present invention advantageously may be used in conjunction with off-the-shelf cameras for cost savings and for easily modifying the system.

In one broad respect, the present invention is directed to a video recording system for effectively recording video images of unaware subjects under a broad range of lighting conditions automatically in response to detection of motion by such subject using a camera system having controls enabling selective operation of such camera system, the video recording system comprising a motion detector operatively associated with such a camera system in order to selectively produce, in response to detection of motion as by such a subject, an output signal for selectively adjusting such camera's light sensitivity and for selectively causing such camera system to begin recording video images of such subject, a light sensitivity adjustment system for ensuring that such camera is able to effectively record video images of such subject under such broad range of lighting conditions in response to receipt of the output signal, the light sensitivity adjustment system comprising a photodetection module operatively associated with the camera system, adapted to detect a light level external to such camera system under which light level an unaware subject would be recorded on video images by such a camera system, and including a camera sensitivity control interface to selectively adjust such camera controls governing the light sensitivity of such camera in order to cause such camera system to have a desired light sensitivity to enable effective video recording of such subject. In a narrow respect, the present invention further comprises a logic control system operatively connected to the motion detector, the control system adapted to programmably select the sensitivity of the motion detector in order to establish a desired threshold of motion in response to which the motion detector will produce an output signal. In a narrower respect, the logic control system is operatively connected to the light sensitivity adjustment system, the control system adapted to programmably select the sensitivity of the camera system in order to establish a desired level of light sensitivity. In another narrow respect, the present invention further comprises a programmable microprocessor-based control system operatively connected to the camera system and the motion detector in order to selectively actuate the camera system so as to cause the camera system to begin recording video images at a desired moment in time. In another narrower respect, the programmable microprocessor-based control system is also adapted to selectively disengage the camera system in order to limit the recording of video images of unaware subjects to a period of time having a desired length. In another narrow respect, the present invention further comprises an infrared lamp system operatively associated with camera system for selectively illuminating an unaware subject in order to provide a desired level of light outside of the range of vision capability of anticipated unaware subjects; and wherein the camera system is adapted to record video images of the unaware subject sufficiently illuminated with infrared lighting.

In another broad respect, the present invention is directed to a video recording system for effectively recording video images of unaware subjects under a broad range of lighting conditions automatically in response to detection of motion by such subject using a camera system having controls enabling selective operation of such camera system, the video recording system comprising a motion detector operatively associated with such a camera system in order to selectively produce, in response to detection of motion as by such a subject, an output signal for selectively engaging a filter system and for selectively causing such camera system to begin recording video images of such subject, a light sensitivity adjustment system for ensuring that such camera is able to effectively record video images of such subject under such broad range of lighting conditions in response to receipt of the output signal, the light sensitivity adjustment system comprising a photodetection module operatively associated with a filter system, adapted to detect a light level external to such camera system under which light level an unaware subject would be recorded on video images by such a camera system; wherein the filter system is adapted to filter light entering such camera in order to compensate for the known degree of light sensitivity of the camera in order to allow effective video recording of such subject. In a narrow respect, the present invention further comprises a logic control system operatively connected to the motion detector, the control system adapted to programmably select the sensitivity of the motion detector in order to establish a desired threshold of motion in response to which the motion detector will produce an output signal. In a narrower respect, the logic control system is operatively connected to the filter system, the control system adapted to programmably select the engagement and disengagement of the filter system in response to the photodetection module in order to facilitate effective recording of video images of unaware subjects under high and low lighting conditions. In another narrow respect, the present invention further comprises a programmable microprocessor-based control system operatively connected to the camera system and the motion detector in order to selectively actuate the camera system so as to cause the camera system to begin recording video images at a desired moment in time. In another narrower respect, the programmable microprocessor-based control system is also adapted to selectively disengage the camera system in order to limit the recording of video images of unaware subjects to a period of time having a desired length. In another narrow respect, the present invention further comprises an infrared lamp system operatively associated with camera system for selectively illuminating an unaware subject in order to provide a desired level of light outside of the range of vision capability of anticipated unaware subjects; and wherein the camera system is adapted to record video images of the unaware subject sufficiently illuminated with infrared lighting.

In another broad respect, the present invention is directed to a video recording method for effectively recording video images of unaware subjects under a broad range of lighting conditions automatically in response to detection of motion by such subject using a camera system having controls enabling selective operation of such camera system, the video recording method comprising the steps of detecting motion as by such a subject; producing an output signal for causing such camera system to begin recording video images of such subject; detecting a light level external to such camera system within which light level an unaware subject is oriented; and selectively adapting the capacity of the camera system to record video images of an unaware subject under the environmental lighting conditions under which the unaware subject is susceptible to recordation by the camera system. In a narrow respect, the present invention further comprises the step of selecting the sensitivity threshold for detecting motion as by a subject in order to establish a desired level of motion sensitivity which will lead to producing an output signal. In a narrower respect, selectively adapting the capacity of the camera system to record video images of an unaware subject under the environmental lighting conditions under which the unaware subject is susceptible to recordation by the camera system comprises and selecting the light sensitivity of the camera system in order to compensate for the known degree of lighting under which the unaware subject is to be recorded by the camera system. In another narrower respect, selectively adapting the capacity of the camera system to record video images of an unaware subject under the environmental lighting conditions under which the unaware subject is susceptible to recordation by the camera system comprises and filtering light entering such camera system in order to compensate for the known degree of light sensitivity of the camera in order to allow effective video recording of such subject. In another narrower respect, the present invention further comprises the step of selectively actuating the camera system from recording video images in order to limit the recording of video images of unaware subjects to a period of time having a desired length. In another narrower respect, casting an infrared light upon the unaware subject in order to illuminate the unaware subject sufficiently to enable effective recording of the subject by the camera system, wherein the wavelength of the infrared light is selected so as to be visually undetectable to anticipated subjects. In another narrower respect, the present invention is adapted to managing recording of video images by the camera system in order to facilitate random access to recorded visual images. In a further narrower respect, the present invention is configured to include circulating air within a housing which contains the camera system in order to mitigate hot spots within the housing.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 is a high level illustration of one embodiment of the present invention.

FIGS. 2A-2C show a filtering system engaged and disengaged and a schematic diagram, in accordance with an embodiment of the present invention.

FIGS. 3A-3E illustrate a filter holder, in accordance with an embodiment of the present invention.

FIG. 4 illustrates an electrical schematic for the microprocessor, in accordance with an embodiment of the present invention.

FIG. 5 depicts system wiring, in accordance with an embodiment of the present invention.

FIG. 6 shows an electrical schematic for the motion detector, in accordance with an embodiment of the present invention.

FIG. 7 depicts an electrical schematic for the infrared lamp, in accordance with an embodiment of the present invention.

FIG. 8 shows an electrical schematic for the camera, in accordance with an embodiment of the present invention.

FIG. 9 shows two views of the main assembly, in accordance with an embodiment of the present invention.

### DETAILED DESCRIPTION OF PREFERRED EMBODIMENTS

The present invention overcomes the shortcomings of current remote monitoring systems with a video recording camera system operable to record video information about an event. The preferred embodiment of the present invention is adapted to permit recording in a range of light conditions, is programmable, can sense events and record events separately, can be used with a pole or tree, and is adapted for use with different off-the-shelf cameras.

The preferred embodiment operates on battery power. However, any source of acceptable electrical power would be within the scope of the present invention.

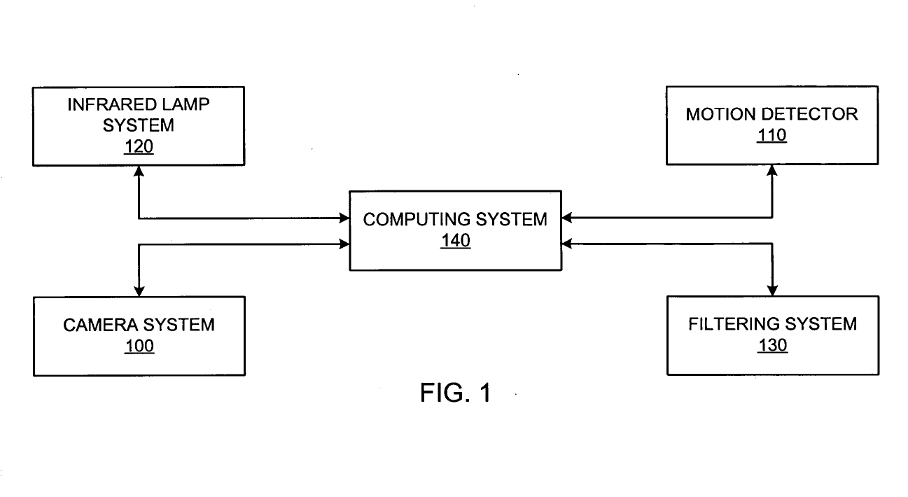

Now referring to the figures, FIG. 1 is a high-level depiction of an infrared-triggered camera system of the present invention. The present invention includes a camera system 100, a motion detection system 110, an infrared lamp system 120, a filtering system 130, and a microprocessor-based computing system 140.

The camera system 100 comprises a video camcorder, web cam, or other video device 105 operable to record video images or transmit the video image or both. In a preferred embodiment, part of the camera system 100 includes an off-the-shelf camcorder 105. Other benefits conferred by this inventive feature that improves upon the current state of the art include improved system flexibility and potentially substantial cost savings. An off-the-shelf camcorder typically includes its own battery power source, which may be maintained and charged separately from any other power source for the present invention.

The use of camcorders 105 may be enabled by implementation of the camera's operating codes. An advantage to this embodiment is that the user does not need any special mechanical or electrical skills to install or uninstall such a video device 105. Thus, the camcorder 105 does not need to be disassembled, deconstructed, or otherwise internally modified to be installed as a functional element of the camera system 100. Many such modifications would violate at least some warranty provisions of those warranties most typically providing coverage of cameras 105 as are currently available on the market by leading camera manufacturers.

In some embodiments, digital video cameras 105 would work equivalently to non-digital video cameras 105 in many respects in the context of appropriately configured systems. Some embodiments according to the present invention implement a digital video camera 105. Advantages of digital video cameras 105 include the ability to conveniently and cost-effectively download images from the camera 105 in electronic format for convenient access, transmittal, and storage.

Structural and functional independence allows embodiments of the present invention to be configurable to modularly cooperate with a camera 105 supplied by the user of the system. Advantageously, cost may thereby be constrained in specific situations in which a camera 105 is available for zero, nominal, or at below-market cost. For example, a user of the system may already own a camera 105. In that situation, the effective marginal cost to the user of using that specific camera 105 in a system 100 configured according to the preferred embodiment of the present invention would essentially be equal to the cost of other uses of the camera 105 foregone as a result of the camera 105 being installed for use in an infrared-triggered camera system 100. The cost should be considered in light of the option of alternating usage of the camera 105 between use in the infrared-triggered camera system 100 and usage as simply a video camcorder 105.

Now referring to FIGS. 1-3, one embodiment of the filtering system 130 of the present invention includes an automatically adjustable neutral density filter 132 configured to enable recording by the camera at lighting levels commensurate with levels typically encountered during day and night without the additional requirement of manual intervention. The filtering system further includes a filter holder 134, a stepping motor 136, and a limit switch 138. In a preferred embodiment, the present invention operates the camera 105 in both daylight and darkness while leaving the camera 105 in a low light operation mode at all times. By leaving the camera 105 in a low light operation mode and placing filters 132 in front of the lens satisfactory results can be obtained by placing a neutral density filter 132 with an optical density of 3 (0.1% transmission) over the lens during the day and removing it at night.

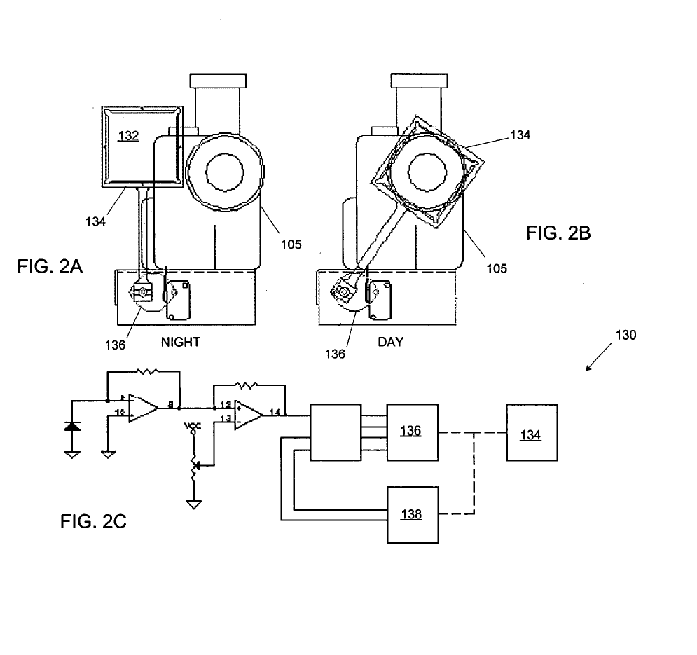

Referring to FIGS. 2A and 2B, front views of the camera 105 are shown with the filter holder located away from the lens for use at night and over the lens for use in daylight. The neutral density filter 132 is integrated with the filter holder 134. The other end of the filter holder 134 is affixed to the shaft of a stepping motor 136 that rotates in order to move the filter 132 over and away from the lens of the video device 105.

FIG. 2C is a schematic of a preferred embodiment of the filtering system 130.

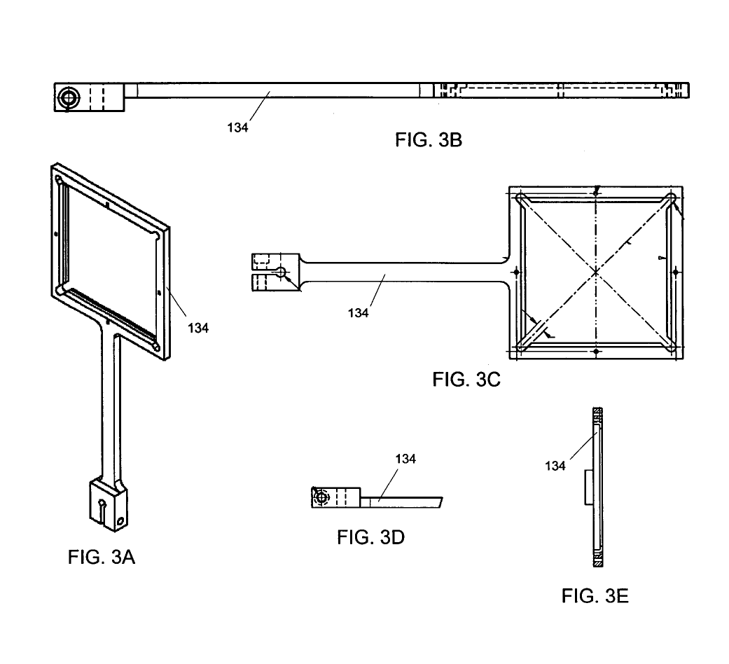

FIGS. 3A-3E are top, side, end, partial, and isometric views of a filter holder 134 in accordance with one embodiment of the present invention. In alternative embodiments, the present invention utilizes a video camera 105 having an integrated filtering system 130. In these embodiments, the present invention is adapted to actuate the filtering system in the camera or the camera is capable of automatically converting itself between low light and high light operating modes.

In an alternative embodiment, the present invention comprises a light sensitivity adjustment system that is adapted to receive a signal corresponding to the light levels and adjust the level of light that is allowed to pass through the system 110 to the camera 105.

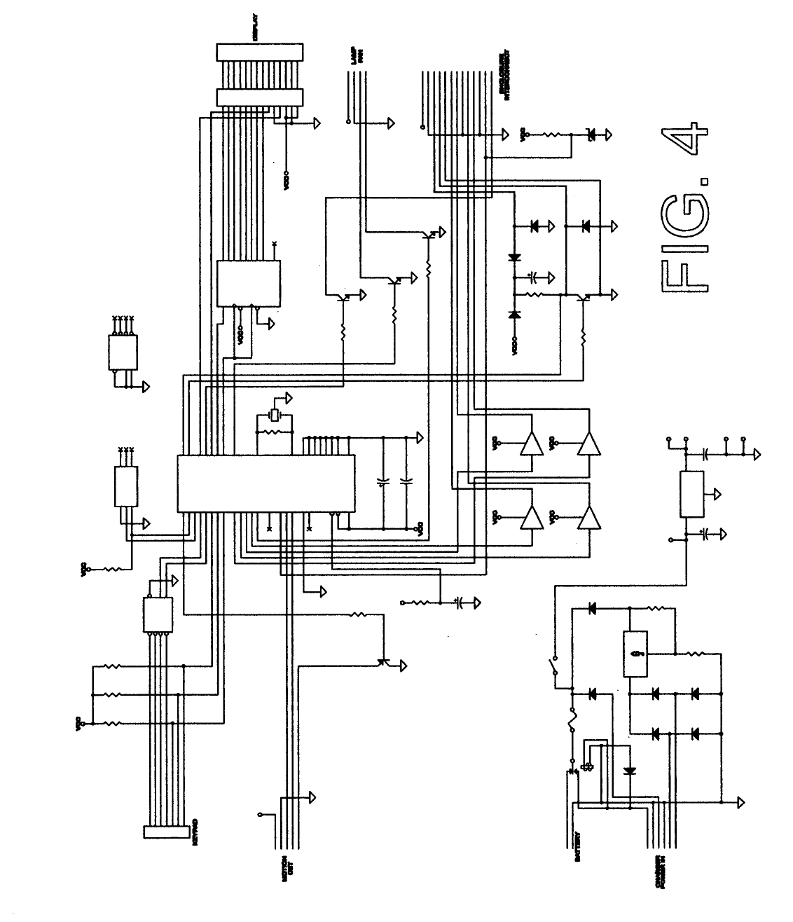

FIG. 4 depicts an electrical schematic of the processor of the computing system. The computing system 140 manages and coordinates operation of the infrared-triggered system as a whole, and includes a processor and memory. The computing system 140 may also incorporate a battery pack or other power source and a cooling fan, which is discussed below.

The computing system 140 is operably connected to all portions of the system, including the camera system 100, the motion detection system 110, the infrared lamp system 120, and the filtering system 130. For purposes of this document, the term operably connected means the computing system 140 is adapted to communicate with the other systems. The connection does not have to be permanent or a physical connection. For example, the connection may be wireless and may only occur when there is a need to communicate between elements.

The computing system 140 may be operable to control any aspect of any part of the system. For example, in some embodiments, the sensitivity of the motion detection system 110 may be adjusted remotely. In some embodiments, the sensitivity of the infrared light system 120 may be adjusted through the computing system 140.

The number of video information segments that can be recorded on a given recording medium in use by the preferred embodiment depends upon many factors, including (1) the programming of the computing system 140, (2) the recording medium capacity, and (3) the camera recording technology. Each segment typically begins with an event. For example, the preferred embodiment includes settings to allow hundreds of segments to be recorded on a single recording medium. Efficient usage of the recording medium reduces the overall system's effective cost of operation by tending to reduce the rate of consumption of recording tapes.

The computing system 140 is fully programmable. For example, recording duration following each event may be selectively programmed, a minimum delay may be implemented that constrains the system in the amount of time that must expire following a given event before a subsequent event will trigger the system to record.

Other parameters relating to the video device 105 may be programmed within the scope of the present invention. In addition, parameters associated with the motion sensing system 110, the infrared lamp system 120, the filtering system 130, and the microprocessor-based computing system 140 may be selectively programmed within the scope of the present invention.

In some embodiments, the infrared camera system is a stand-alone unit. In other embodiments, the computing system 140 is adapted to communicate with a user through wired or wireless networks.

In the preferred embodiment, the computing system 140 is implemented so as to allow tagging of individual recorded video information. This would allow any event to be quickly accessed for viewing, despite use of a non-random-access medium such as super 8 or digital tape in some embodiments. For example, if a recorded tape segment included video information triggered by the event of a deer passing within range of the sensing system 110, then that event could be tagged for ease and speed in quick future access to view the corresponding video segment.

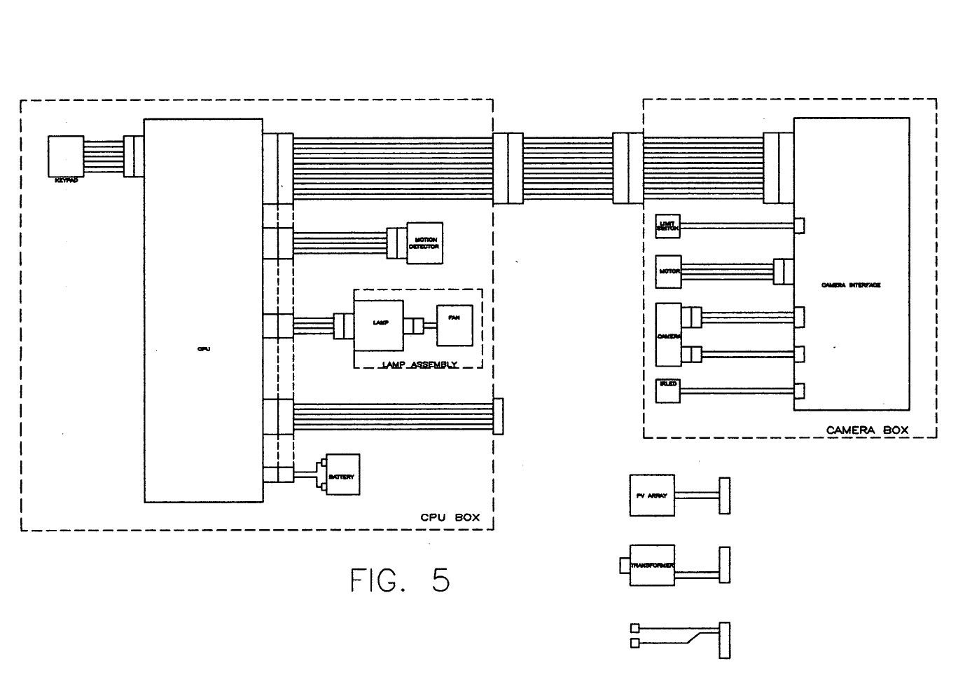

FIG. 5 is a schematic diagram of one embodiment of the present invention.

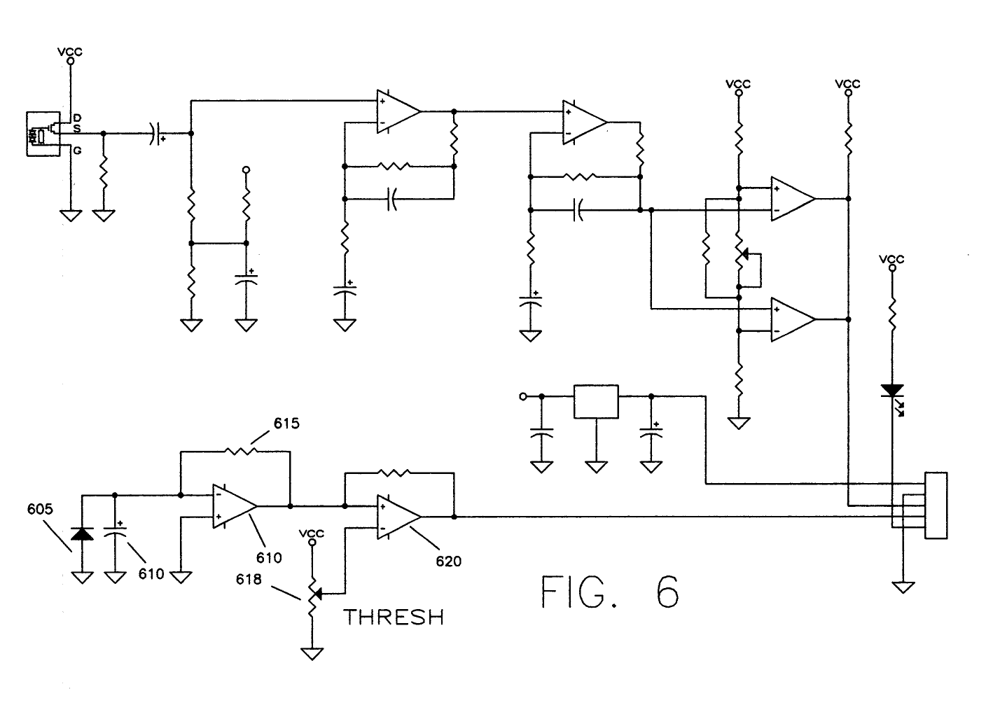

Now referring to FIGS. 1 and 6, a preferred embodiment of the sensing system 110 comprises a photovoltaic cell to detect motion to enable the system 100 to record relevant events.

In order to detect daylight, a photodiode (PD1) 605 operating in photovoltaic mode is subjected to radiation from the infrared through the visible portion of the spectrum. PD1 605 generates a voltage that is based on the intensity of the radiation. This voltage is presented to the inverting input of an operational amplifier, U1C, 610 which causes a current to flow from the output of U1C 610 through resistor R13 615, which will force the voltage on the inverting input to be equal to the voltage on the non-inverting input of the op-amp 610. Since the non-inverting input is at zero volts (ground), the voltage on the op-amp's output will go to whatever voltage is required to cause the inverting input to go to ground, effectively shorting out the output of the photodiode 605. In that way, the output of the photodiode 605 is forced to zero volts, causing its output current to change the output voltage of the op-amp 610 with changes in the intensity of the light impinging upon the photodiode 605.

A second op-amp, U1D, 620 is used as a voltage comparator to set the daylight detection threshold. A second resistor R14 618 is a variable resistor used as a potentiometer, and is used to vary the voltage on the inverting input of U1D 620.

If the voltage on the non-inverting input is higher than the voltage on the inverting input, the voltage on the output of U1D 620 will rise to its maximum. If the voltage on the non-inverting input is lower than the voltage on the inverting input, the voltage on the of U1D 620 will fall to its minimum. This conversion from the analog to the digital domain is used in a preferred embodiment to define the switching point between daylight and darkness; and by varying the voltage on the inverting input of U1D 620, the voltage generated by the illumination of the photodiode 605 can be used to determine the day/night differentiation.

The output from U1D 620, being digital, is sent to a microcontroller and the course of action planned for either daylight or darkness taken as U1D's output goes high or low. If it is daylight, the comparator's output goes high and the microcontroller will drive the stepping motor 136 in the required direction to cover the camera lens with the neutral density filter 132 until the limit switch 138 is actuated. At this point the filter 132 will be directly over the camera lens as shown in FIG. 2B and the motor 136 will be stopped. If the comparator's output goes low and the limit switch 138 is not closed, the microcontroller will actuate the stepping motor 136 to drive the filter holder 134 toward the lens until the limit switch 138 is actuated. Once that happens, the filter holder 134 will be driven away from the lens until the lens is completely unobscured as shown in FIG. 2A, at which point the motor 136 will be stopped. If the comparator's output goes low and the limit switch has already been actuated, the microcontroller will actuate the stepping motor 136 drive the filter 132 away from the lens until the lens is unobscured and then the motor 136 will be stopped.

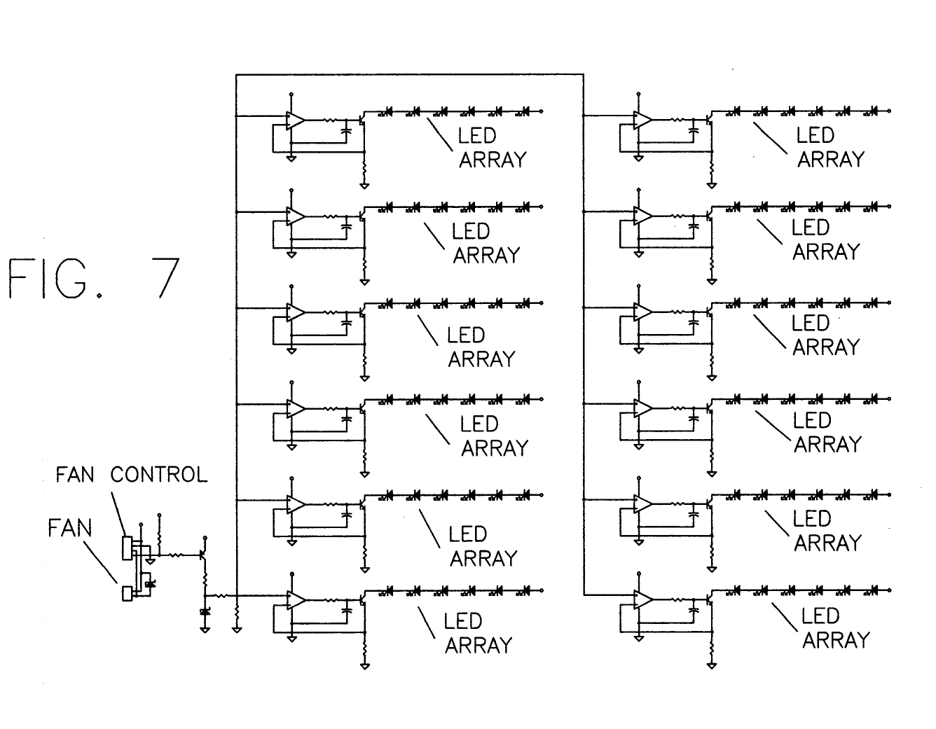

Now referring to FIGS. 1 and 7, a preferred embodiment of the lighting system 120 includes infrared lamps 122 to provide infrared light to allow effective operation during nighttime or other low light conditions.

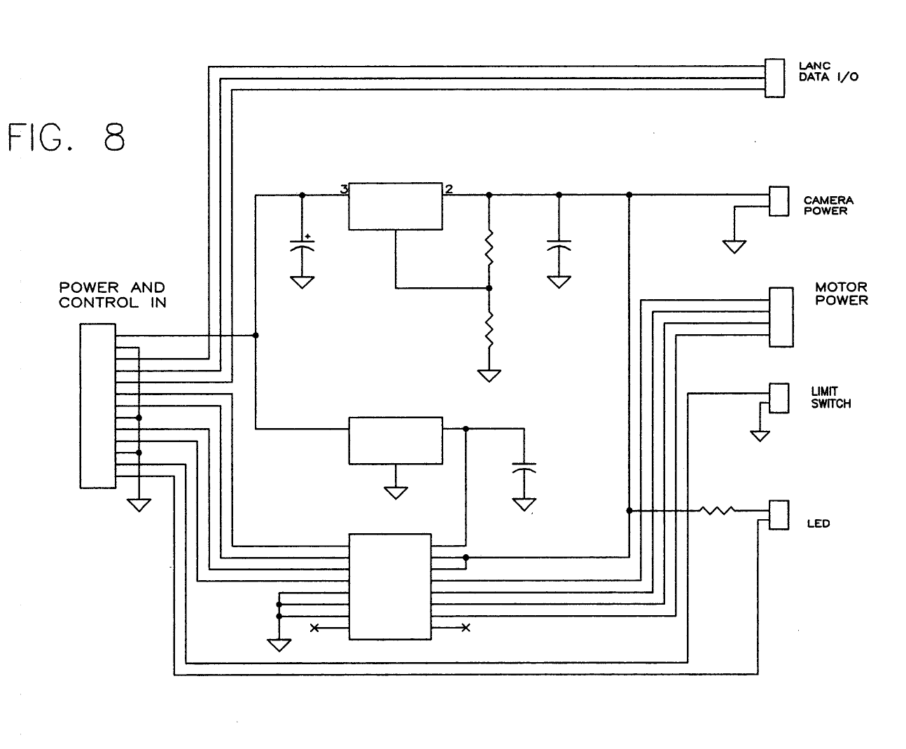

FIGS. 7 and 8 respectively describe the electrical systems of the infrared lamp system and the camera system.

The infrared lamp system 120 is comprised of at least one infrared light-emitting source. In some embodiments, the infrared lamp system 120 uses a single light-emitting source to provide sufficient lighting for the camera system 100. In some embodiments, an array of LEDs provides a light source necessary for the camera system 100 to operate in a preferred mode. The light emitted by the infrared lamp system 120 is ideally undetectable to any subject near the system. In some situations, the infrared light may be emitted at a 750 nanometer average wavelength. This wavelength may be acceptable in wildlife settings because the wildlife might not be spooked by the light. However, if the present invention is for use near people, a higher frequency may be preferred due to some people's ability to see light in the 700-750 nanometer range. In those settings, a 900+nanometer output may be desirable.

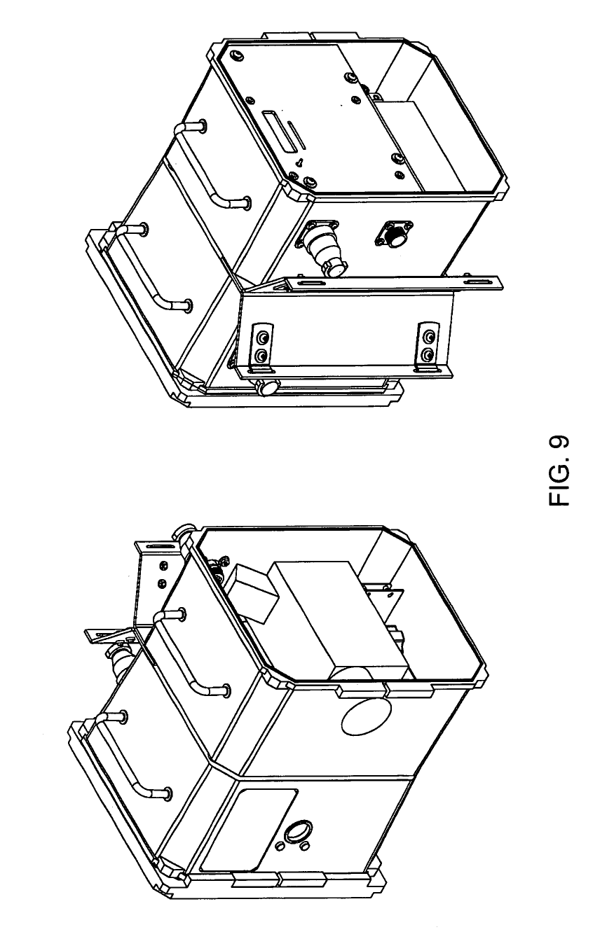

Now referring to FIG. 9, a preferred embodiment is shown in which the system is separated into two compartments which may be joined as shown in FIG. 9 or may be separated. In this embodiment, a first compartment, the camcorder enclosure, houses a camcorder 605, filter assembly 130, and interface circuit board, and a second compartment, the CPU enclosure, houses a programming keypad, detection assembly 110, microprocessor and printed circuit board 140, LED alignment indicator, and infrared array 120. The present invention may further include a power supply cable configured to engage a battery, a transformer system that plugs into the AC mains and provides low voltage AC to the internal battery charger, and a photovoltaic array used to charge the system battery (not shown).

A bracket on the rear side of the housing can be used to mount the housing to a post, tree, stump, etc.

The preferred embodiment illustrated in FIG. 9 weighs 23.5 pounds and its housing is waterproof. Alternatively, if the housing is constructed of ABS plastic, then its weight will be significantly less. An accessory kit (not shown) conveniently enables quick and easy mounting of multiple infrared-triggered camera systems, currently at separation distances of up to 200 feet. This separated coordination of multiple systems supports strong security applications. Each system is 12 inches wide×10 inches deep×11 inches tall, occupying 0.77 ft³.

Each system includes an innovative bracket fastening system well adapted to fastening the system to a post, tree, or stump of accommodating diameter. Additionally the system may simply be placed so as to rest on the ground without impairing its effective operation. By way of example, a typical camcorder recording medium may be used for recording video information by the camera (e.g., camcorder). The preferred embodiment as shown is adapted to operate in coordination with at least certain camcorders such as Sony™ Models TRV 330, 530, 340, and 740.

The two boxes, with systems 100, 110, 120, 130, and 140 installed, are readily separable. As described above, the computing device is preferably housed with the sensing system, but need not be so housed.

Other features and adaptations of various embodiments include a user-accessible contrast control and a reset switch.

Some embodiments may include a fan control because even though embodiments of the present invention may be sealed and permit very limited air circulation, a cooling fan may be beneficial. For example, a system may be sealed to prevent moisture from entering and insects from entering, so the CPU enclosure may be sealed to prevent damage. However, sealing the CPU enclosure will prevent air from freely circulating past the components. Furthermore, the embodiment may have sufficient surface area to dissipate the heat created by the infrared lamp system 120, but the cooling may be localized to the IR lamp system 120 and portions of the device may overheat. In these situations, a cooling fan in a sealed enclosure circulates air past components to eliminate hot spots and create even heating. Since the sealed enclosure has sufficient surface area to dissipate the total heat, the system remains cool and is not damaged by hot spots.

Appendix A contains a set of operating instructions for an embodiment. In particular, the embodiment to which Appendix A pertains is Stumpcam™ Model 9945, which predates Model 9951.

While many variations and modifications have been suggested implicitly or explicitly throughout the disclosure of this application, additional modifications and variations may be implemented in other embodiments of the present invention. Such modifications and variations are within the scope of the present invention.

For example, the present invention may use physical wire connections between systems to coordinate multiple systems, but wireless communications between systems may also be implemented in other embodiments according to the present invention. Embodiments of the present invention may locally store recorded video information, and some embodiments may transmit the video information. Also, the functionality of the present invention has been described using hardware to perform certain aspects, but the present invention is programmable and these functions may be controlled by microprocessors. For example, a potentiometer may be obsolete in some microprocessor-controlled embodiments. Still other embodiments may record and transmit the video information. The video information may be transmitted via the Internet or any other network.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provision of 35 U.S.C. § 112, ¶6.

It should be apparent from the foregoing that an invention having significant advantages has been provided. While the invention is shown in only a few of its forms, it is not just limited to those forms but is susceptible to various changes and modifications without departing from the spirit thereof.

What is claimed is:

1. A video recording system for effectively recording video images of unaware subjects under a broad range of lighting conditions automatically in response to detection of motion by such subject using a camera system having controls enabling selective operation of such camera system, the video recording system comprising:
a motion detector operatively associated with such a camera system in order to selectively produce, in response to detection of motion as by such a subject, an output signal for selectively adjusting such camera's light sensitivity and for selectively causing such camera system to begin recording video images of such subject;
a light sensitivity adjustment system for ensuring that such camera is able to effectively record video images of such subject under such broad range of lighting conditions in response to receipt of the output signal, the light sensitivity adjustment system comprising:
a photodetection module operatively associated with the camera system, adapted to detect a light level external to such camera system under which light level an unaware subject would be recorded on video images by such a camera system, and including a camera sensitivity control interface to selectively adjust such camera controls governing the light sensitivity of such camera in order to cause such camera system to have a desired light sensitivity to enable effective video recording of such subject.

2. The video recording system in accordance with claim 1, further comprising:
a logic control system operatively connected to the motion detector, the control system adapted to programmably select the sensitivity of the motion detector in order to establish a desired threshold of motion in response to which the motion detector will produce an output signal.

3. The video recording system in accordance with claim 2, wherein the logic control system is operatively connected to the light sensitivity adjustment system, the control system adapted to programmably select the sensitivity of the camera system in order to establish a desired level of light sensitivity.

4. The video recording system in accordance with claim 1, further comprising:
a programmable microprocessor-based control system operatively connected to the camera system and the motion detector in order to selectively actuate the camera system so as to cause the camera system to begin recording video images at a desired moment in time.

5. The video recording system in accordance with claim 4, wherein the programmable microprocessor-based control system is also adapted to selectively disengage the camera system in order to limit the recording of video images of unaware subjects to a period of time having a desired length.

6. The video recording system in accordance with claim 1, further comprising:
an infrared lamp system operatively associated with camera system for selectively illuminating an unaware subject in order to provide a desired level of light outside of the range of vision capability of anticipated unaware subjects; and
wherein the camera system is adapted to record video images of the unaware subject sufficiently illuminated with infrared lighting.

7. A video recording system for effectively recording video images of unaware subjects under a broad range of lighting conditions automatically in response to detection of motion by such subject using a camera system having controls enabling selective operation of such camera system, the video recording system comprising:
a motion detector operatively associated with such a camera system in order to selectively produce, in response to detection of motion as by such a subject, an output signal for selectively engaging a filter system and for selectively causing such camera system to begin recording video images of such subject;
a light sensitivity adjustment system for ensuring that such camera is able to effectively record video images of such subject under such broad range of lighting conditions in response to receipt of the output signal, the light sensitivity adjustment system comprising:
a photodetection module operatively associated with a filter system, adapted to detect a light level external to such camera system under which light level an unaware subject would be recorded on video images by such a camera system;
wherein the filter system is adapted to filter light entering such camera in order to compensate for the known degree of light sensitivity of the camera in order to allow effective video recording of such subject.

8. The video recording system according to claim 7, further comprising:
a logic control system operatively connected to the motion detector, the control system adapted to programmably select the sensitivity of the motion detector in order to establish a desired threshold of motion in response to which the motion detector will produce an output signal.

9. The video recording system in accordance with claim 8, wherein the logic control system is operatively connected to the filter system, the control system adapted to programmably select the engagement and disengagement of the filter system in response to the photodetection module in order to facilitate effective recording of video images of unaware subjects under high and low lighting conditions.

10. The video recording system in accordance with claim 7, further comprising:
a programmable microprocessor-based control system operatively connected to the camera system and the motion detector in order to selectively actuate the camera system so as to cause the camera system to begin recording video images at a desired moment in time.

11. The video recording system in accordance with claim 10, wherein the programmable microprocessor-based control system is also adapted to selectively disengage the camera system in order to limit the recording of video images of unaware subjects to a period of time having a desired length.

12. The video recording system in accordance with claim 7, further comprising:
an infrared lamp system operatively associated with camera system for selectively illuminating an unaware subject in order to provide a desired level of light outside of the range of vision capability of anticipated unaware subjects; and
wherein the camera system is adapted to record video images of the unaware subject sufficiently illuminated with infrared lighting.

13. A video recording method for effectively recording video images of unaware subjects under a broad range of lighting conditions automatically in response to detection of motion by such subject using a camera system having controls enabling selective operation of such camera system, the video recording method comprising the steps of:
detecting motion as by such a subject;
upon the detecting of motion, producing an output signal for causing such camera system to begin recording video images of such subject;
upon receipt of the output signal, detecting a light level external to such camera system within which light level an unaware subject is oriented;
selectively adapting the capacity of the camera system to record video images of an unaware subject under the environmental lighting conditions under which the unaware subject is susceptible to recordation by the camera system.

14. The video recording method of claim 13, further comprising:
selecting the sensitivity threshold for detecting motion as by a subject in order to establish a desired level of motion sensitivity which will lead to producing an output signal.

15. The video recording method of claim 14, wherein the selectively adapting the capacity of the camera system to record video images of an unaware subject under the environmental lighting conditions under which the unaware subject is susceptible to recordation by the camera system comprises:
selecting the light sensitivity of the camera system in order to compensate for the known degree of lighting under which the unaware subject is to be recorded by the camera system.

16. The video recording method of claim 14, wherein the selectively adapting the capacity of the camera system to record video images of an unaware subject under the environmental lighting conditions under which the unaware subject is susceptible to recordation by the camera system comprises:
filtering light entering such camera system in order to compensate for the known degree of light sensitivity of the camera in order to allow effective video recording of such subject.

17. The video recording method of claim 13, further comprising:
selectively disengaging the camera system from recording video images in order to limit the recording of video images of unaware subjects to a period of time having a desired length.

18. The video recording method of claim 13, further comprising:
casting an infrared light upon the unaware subject in order to illuminate the unaware subject sufficiently to enable effective recording of the subject by the camera system, wherein the wavelength of the infrared light is selected so as to be visually undetectable to anticipated subjects.

19. The video recording method of claim 13, further comprising:
managing recording of video images by the camera system in order to facilitate random access to recorded visual images.

20. The video recording method of claim 13, further comprising:
circulating air within a housing which contains the camera system in order to mitigate hot spots within the housing.
